(19) United States
(12) Patent Application Publication
(10) Pub. No.: US 2026/0128783 A1
(43) Pub. Date: May 7, 2026

(54) CONTROL METHODS FOR RECEIVER ANTENNA SELECTION AND INTERFERENCE CANCELATION AND APPARATUS THEREOF

(71) Applicant: MEDIATEK INC., Hsinchu City (TW)

(72) Inventors: Cheng-Yi HSU, Hsinchu City (TW); Kai-Hsiang HO, Hsinchu City (TW); Yuan YUAN, Beijing (CN); Chih-Chieh LAI, Hsinchu City (TW)

(21) Appl. No.: 18/937,351

(22) Filed: Nov. 5, 2024

(51) Int. Cl. H04B 7/08; H04B 17/309; H04W 72/231

(52) U.S. Cl. CPC H04B 7/082; H04B 17/346; H04W 72/231

(57) ABSTRACT

A control method for receiver antenna selection (RAS) and interference cancelation (IC) is provided. The control method for RAS and IC may be applied to an apparatus. The control method for RAS and IC may include the following steps. The apparatus may determine at least one scenario associated with the operating environment of the apparatus. Then, the apparatus may determine a plurality of parameters that correspond to the at least one scenario. Then, based on these parameters, the apparatus may determine how many antennas are needed and determine whether to enable an IC module.

### BACKGROUND OF THE INVENTION

### Field of the Invention

The invention generally relates to communication technology, and more particularly, to operations for controlling a receiver (receiving) antenna selection (RAS) and interference cancelation (IC).

### Description of the Related Art

Unless otherwise indicated herein, approaches described in this section are not prior art to the claims listed below and are not admitted as prior art by inclusion in this section.

In conventional communication technologies, a UE (user equipment) may use the receiver antenna selection (RAS) to control the selection of the receiver antenna number. That is, the RAS may be used to determine how many antennas are needed. In addition, in conventional communication technologies, the UE may use interference cancelation (IC) to cancel the interference from other cells.

However, when the throughput benefit of enabling the IC or using more antennas is lower than the power consumption of the UE, the UE may not immediately adjust the RAS and IC operations at the same time to achieve a better balance between the throughput benefit and power consumption.

Therefore, how to achieve a better balance between the throughput benefit and power consumption by controlling the RAS and IC is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to control methods for receiver antenna selection (RAS) and interference cancelation (IC) with respect to user equipment (UE). It is believed that the above-described issue would be avoided or otherwise alleviated by implementing one or more of the proposed schemes described herein.

An embodiment of the invention provides a control method for receiver antenna selection (RAS) and interference cancelation (IC). The control method for RAS and IC may be applied to an apparatus. The control method for RAS and IC may include the following steps. The apparatus may determine at least one scenario associated with the operating environment of the apparatus. Then, the apparatus may determine a plurality of parameters that correspond to the at least one scenario. Then, based on these parameters, the apparatus may determine how many antennas are needed and determine whether to enable an IC module.

In some embodiments, the scenarios may be associated with the transmission mode, the cell identification (ID) of an interference cell, the loading of the interference cell, and the channel type.

In some embodiments, the parameters comprise the interference-to-noise ratio (INR), the signal-to-interference-plus-noise ratio (SINR), the block error rate (BLER), the throughput (Tput) degradation ratio and the downlink control information (DCI) missing indicator.

In some embodiments, the apparatus may enable the IC module in an event that the INR exceeds the threshold. In addition, the apparatus may disable the IC module in an event that the INR does not exceed the threshold.

In some embodiments, the apparatus may determine to use the first number of antennas in an event that the SINR exceeds the threshold. In addition, the apparatus may determine to use the second number of antennas in an event that the SINR does not exceed the threshold. The second number may be higher than the first number. The first number may be 1 or higher than 1, and the second number may be higher than 1.

An embodiment of the invention provides an apparatus. The apparatus may include a transceiver and a processor. The transceiver may comprise a plurality of antennas. The transceiver may be configured to perform wireless transmission to and reception from a network node. The processor may be coupled to the transceiver. The processor may perform the following operations. The operations may comprise determining at least one scenario associated with the operating environment of the apparatus. The operations may comprise determining a plurality of parameters that correspond to the at least one scenario. The operations may comprise determining how many antennas need to be used and whether to enable the IC module, based on the aforementioned parameters.

Other aspects and features of the invention will become apparent to those with ordinary skill in the art upon review of the following descriptions of specific embodiments of the control method for RAS and IC, and the apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus 200 according to an embodiment of the application.

FIG. 3 is a block diagram illustrating a network node 300 according to an embodiment of the application.

FIG. 4 is a schematic diagram illustrating a transition state according to an embodiment of the invention.

FIG. 5 is a flow chart illustrating a control method for RAS and IC according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

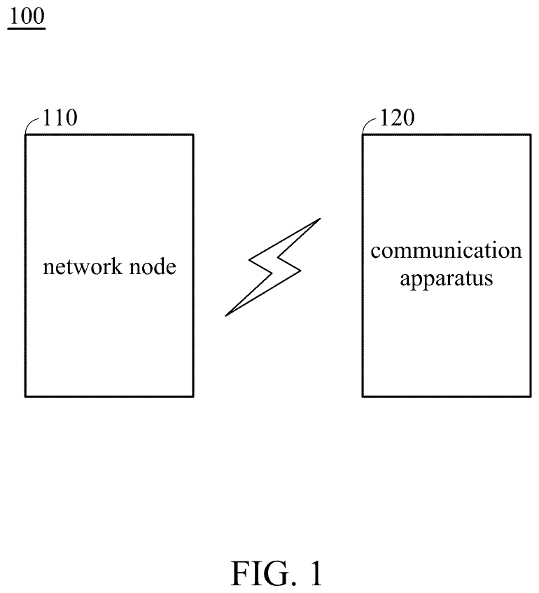

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the network node 110 may be an entity compatible with the Institute of Electrical and Electronics Engineers (IEEE) 802.11 standards to provide and manage the access to the wireless medium for the communication apparatus 120.

In the embodiments of the invention, the communication apparatus 120 may be a user equipment (UE), a non-AP station (STA), a smartphone, Personal Data Assistant (PDA), pager, laptop computer, desktop computer, wireless handset, or any computing device that includes a wireless communications interface. In addition, the communication apparatus 120 may be an entity compatible with the Institute of Electrical and Electronics Engineers (IEEE) 802.11 standards.

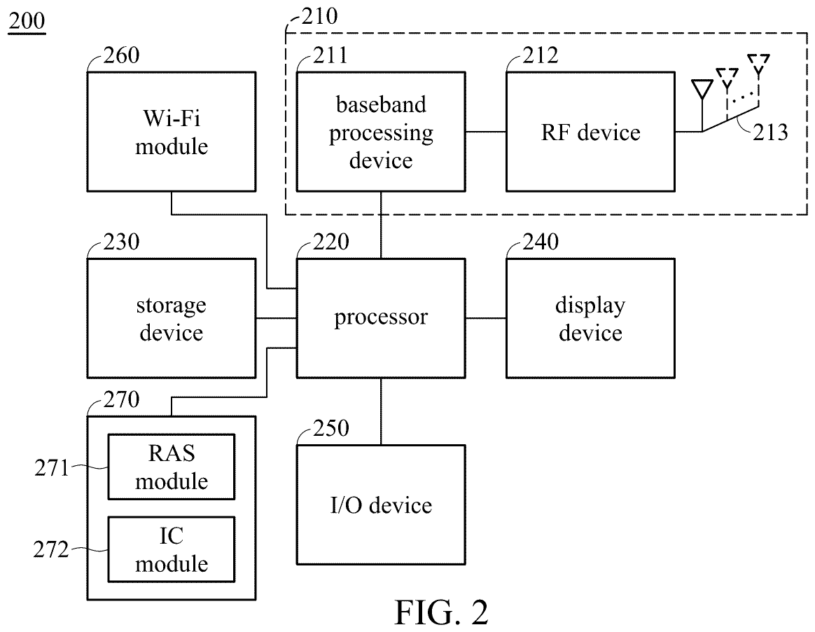

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, a Wi-Fi module 260, and function modules and circuits 270.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, the Wi-Fi module 260, the function modules and circuits 270 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi module 260 may comprise Wi-Fi antenna and may be configured to perform the operations of Wi-Fi communications.

According to an embodiment of the invention, the function modules and circuits 270 may comprise a receiver antenna selection (RAS) module (or circuit) 271 and an interference cancelation (IC) module (or circuit) 272. The processor 220 may execute different modules or circuits in the function modules and circuits 270 to perform embodiments of the present invention. In the embodiment of the invention, the RAS module 271 may be configured to perform the receiver antenna selection, i.e., the RAS module 271 may be used to determine the number of the antennas which the communication apparatus 200 needs to use. For example, the RAS module 271 may determine to use one antenna (or 1 RX) or two antennas (or 2 RXs) for data transmission, but the invention should not be limited thereto. In the embodiment of the invention, the IC module 272 may be configured to cancel the interference from the neighbor cells. The processor 220 may control the RAS module 271 and the IC module 272 according to the scenarios associated with an operating environment of the communication apparatus 200. Details will be discussed below.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

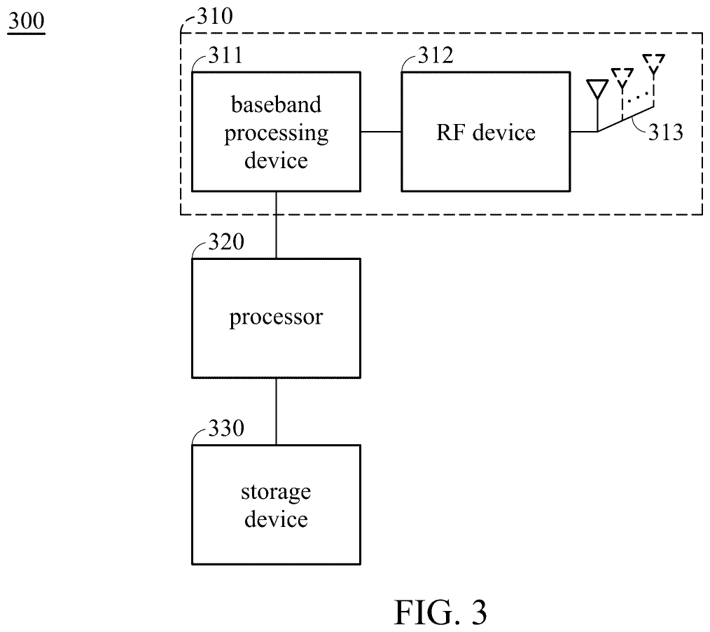

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal as processing, such ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, an apparatus (e.g., communication apparatus 120) may determine at least one scenario associated with an operating environment of the apparatus. Then, the apparatus may determine a plurality of parameters that correspond to the at least one scenario. Different scenarios may correspond to different parameters. Then, according to the values of the parameters, the apparatus may determine the operations of the RAS module and the IC module of the apparatus. That is, according to the values of the parameters corresponding to the current scenario (or scenarios), the apparatus may determine the number of antennas which need to be used (i.e., determine how many antennas are needed) and determine whether to enable an IC module. In the embodiment of the invention, the apparatus may consider the operations of the RAS module and the IC module at the same time to achieve a better balance between the throughput and power consumption of the apparatus.

According to an embodiment of the invention, the at least one scenario may comprise (be associated with) the transmission mode, the cell identification (ID) of an interference cell (or cell colliding type), the loading of the interference cell, and the channel type.

According to an embodiment of the invention, the apparatus may determine the current transmission mode based on a pre-defined table (e.g., Table 1, but the invention should not be limited thereto). The table may comprise different transmission modes and the transmission schemes corresponding to the different transmission modes.

TABLE 1

| Transmission mode | Transmission scheme |
|---|---|
| 1 | Single-antenna port, port 0 |
| 2 | Transmission diversity |
| 3 | Transmission diversity if the associated rank |
| | indicator is 1, otherwise large delay cyclic delay |
| | diversity (CDD) |
| 4 | Closed-loop spacial multiplexing |
| 5 | Multi-user MIMO |
| 6 | Closed-loop spacial multiplexing with a single |
| | transmission layer |
| 7 | If the number of PBCH antenna ports is one, |
| | Single-antenna port, port 0; otherwise transmit |
| | diversity |

According to an embodiment of the invention, if mod (| serving cell ID−interference cell ID|, 3)=0, it may mean that the current cell colliding type is colliding type. In addition, if mod (| serving cell ID−interference cell ID|, 3)≠0, it may mean that the current cell colliding type is non-colliding type.

According to an embodiment of the invention, a plurality of physical resource blocks (PRBs) (e.g., X PRBs, where X is a pre-defined value) may be defined in the serving cell bandwidth. In the serving cell bandwidth, when the number of PRBs of the allocated physical downlink shared channel (PDSCH) of the interference cell that overlaps is Y, Y/X may be defined as the loading of the interference cell.

According to an embodiment of the invention, the channel type may comprise different channel models, e.g., Extended Pedestrian A mode 5 Hz (EPA-5), Extended Typical Urban 70 Hz (ETU-70), but the invention should not be limited thereto.

According to an embodiment of the invention, the parameters may comprise an interference-to-noise ratio (INR), a signal-to-interference-plus-noise ratio (SINR), block error rate (BLER), a throughput (Tput) degradation ratio and a-downlink-control-information (DCI) missing indicator.

According to an embodiment of the invention, when the INR exceeds the threshold (e.g., INR>X dB, where X is a pre-defined value), the apparatus may enable the IC module. In addition, when the INR does not exceed the threshold, the apparatus may disable the IC module.

According to an embodiment of the invention, when the SINR exceeds the threshold (e.g., SINR>Y dB, where Y is a pre-defined value), the apparatus may determine to use the first number of antennas (e.g., use 1 RX, but the invention should not be limited thereto)). In addition, when the SINR does not exceed the threshold, the apparatus may determine to use the second number of antennas (e.g., use 2 RXs, but the invention should not be limited thereto). In the embodiment, the second number may be higher than the first number. The first number may be 1 or higher than 1, and the second number may be higher than 1.

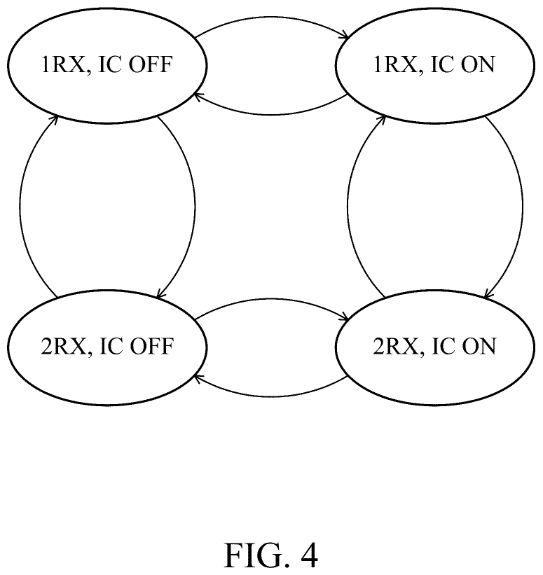

FIG. 4 is a schematic diagram illustrating a transition state according to an embodiment of the invention. As shown in FIG. 4, the apparatus may switch to different states according to the current scenario (or scenarios) and the parameters corresponding to the current scenario (or scenarios). It should be noted that the transition state may be associated with the switch between 1 RX and 2RXs, but the invention should not be limited thereto. The embodiment of the invention also can be applied to other transition states, e.g., the switch between 2 RXs and 4 RXs, or the switch between 4 RXs and 8 RXs.

As shown in FIG. 4, in an example, when the apparatus is operating in the state (1 RX, IC OFF) and the INR (or BLER or Tput degradation ratio) is higher than a pre-defined threshold (e.g., INR>Y1 dB, BLER>B1%, or Tput>T1%, where Y1, B1, and T1 are pre-defined values) (or the apparatus detects the DCI missing event), the apparatus may switch to the state (1 RX, IC ON). That is, the apparatus may enable the IC module to cancel the interference.

As shown in FIG. 4, in another example, when the apparatus is operating in the state (1 RX, IC ON) and the INR does not exceed a pre-defined threshold (e.g., INR<Y1 dB, i.e., the interference is very little, or the co-channel interference (CCI) does not occur), the apparatus may switch to the state (1 RX, IC OFF). That is, the apparatus may disable the IC module.

As shown in FIG. 4, in another example, when the apparatus is operating in the state (1 RX, IC ON) and the SINR does not exceed a pre-defined threshold (or BLER or Tput degradation ratio exceeds a pre-defined threshold, or the apparatus detects the DCI missing event) (e.g., SINR<X1 dB, BLER>B2%, or Tput>T2%, where X1, B2, and T2 are pre-defined values), the apparatus may switch to the state (2 RX, IC ON). In the example, the apparatus may determine that the CCI occurs (or the CCI exists).

As shown in FIG. 4, in another example, when the apparatus is operating in the state (1 RX, IC OFF) and the SINR does not exceed a pre-defined threshold (or the BLER or Tput degradation ratio exceeds a pre-defined threshold, or the apparatus detects the DCI missing event) (e.g., SINR<X1′ dB, BLER>B2′%, or Tput>T2′%, where X1′, B2′, and T2′ are pre-defined values), the apparatus may switch to the state (2 RX, IC OFF). In the example, the apparatus may determine that the CCI does not occur (or no CCI exists). In the example, X1′ may be smaller than X1 or similar to X1.

As shown in FIG. 4, in another example, when the apparatus is operating in the state (2 RX, IC OFF) and the INR (or BLER or Tput degradation ratio) exceeds a pre-defined threshold (e.g., INR>Y2 dB, BLER>B3%, or Tput>T3%, where Y2, B3, and T3 are pre-defined values) (or the apparatus detects the DCI missing event), the apparatus may switch to the state (2 RX, IC ON). That is, the apparatus may enable the IC module to cancel the interference.

As shown in FIG. 4, in another example, when the apparatus is operating in the state (2 RX, IC ON) and the INR does not exceed a pre-defined threshold (e.g., INR<Y2 dB, i.e., the interference is very little, or the CCI does not occur), the apparatus may switch to the state (2 RX, IC OFF). That is, the apparatus may disable the IC module.

As shown in FIG. 4, in another example, when the apparatus is operating in the state (2 RX, IC ON), the SINR exceeds a pre-defined threshold, and BLER does not exceed a pre-defined threshold (e.g., SINR>X1 dB, and BLER<Q1%, where X1 and Q1 are pre-defined values), the apparatus may switch to the state (1 RX, IC ON). In the example, the apparatus may determine that the CCI occurs (or the CCI exists), but the interference is not large enough.

As shown in FIG. 4, in another example, when the apparatus is operating in the state (2RX, IC OFF), the SINR exceeds a pre-defined threshold, and BLER does not exceed a pre-defined threshold (e.g., SINR>X1′ dB, and BLER<Q2%, where X1′ and Q2 are pre-defined values), the apparatus may switch to the state (1 RX, IC OFF). In the example, the apparatus may determine that the CCI does not occur (or no CCI exists). In the example, X1′ may be smaller than X1 or similar to X1.

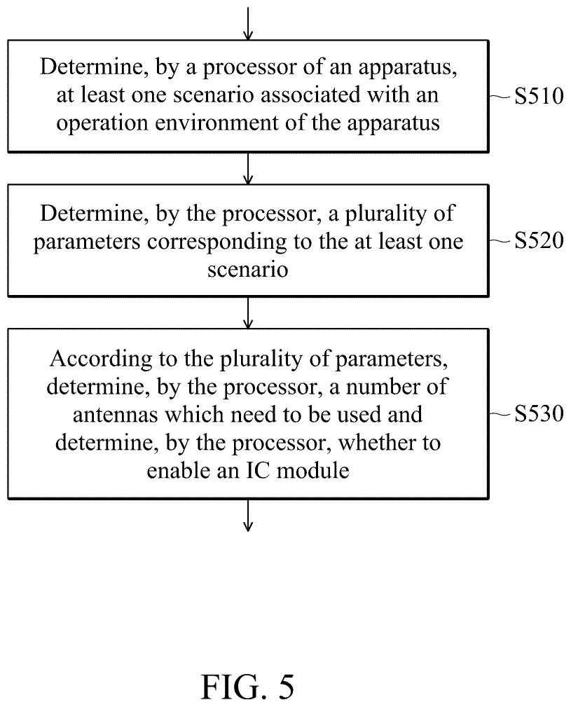

FIG. 5 is a flow chart illustrating a control method for RAS and IC according to an embodiment of the invention. The control method for RAS and IC can be applied to the communication apparatus 120 of wireless communication system 100. As shown in FIG. 5, in step S510, an apparatus (e.g., the communication apparatus 120) may determine at least one scenario associated with an operating environment of the apparatus.

In step S520, the apparatus may determine a plurality of parameters that correspond to the at least one scenario.

In step S530, according to the plurality of parameters, the apparatus may determine the number of antennas which need to be used and determine whether to enable an IC module of the apparatus.

According to an embodiment of the invention, in the control method for RAS and IC, the at least one scenario may comprise the transmission mode, the cell identification (ID) of an interference cell, the loading of the interference cell, and the channel type.

According to an embodiment of the invention, in the control method for RAS and IC, the parameters may comprise an interference-to-noise ratio (INR), a signal-to-interference-plus-noise ratio (SINR), block error rate (BLER), a throughput (Tput) degradation ratio and a downlink-control-information (DCI) missing indicator.

According to an embodiment of the invention, in the control method for RAS and IC, the apparatus may enable the IC module in an event that the INR exceeds the threshold, and disable the IC module the INR does not exceed the threshold.

According to an embodiment of the invention, in the control method for RAS and IC, the apparatus may determine to use a first number of antennas in an event that the SINR exceeds the threshold, and determine to use a second number of antennas in an event that the SINR does not exceed the threshold. The second number may be higher than the first number. The first number may be 1 or higher than 1, and the second number may be higher than 1.

According to the control method for RAS and IC provided in the invention, the apparatus can consider the RAS and IC at the same time. Therefore, better balance between the throughput and power consumption can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A control method for receiver antenna selection (RAS) and interference cancelation (IC), comprising:
determining, by a processor of an apparatus, at least one scenario associated with an operating environment of the apparatus; and
determining, by the processor, a plurality of parameters corresponding to the at least one scenario; and
according to the plurality of parameters, determining, by the processor, a number of antennas which need to be used and determining, by the processor, whether to enable an IC module.

2. The control method for the RAS and IC of claim 1, wherein the at least one scenario comprises a transmission mode, a cell identification (ID) of an interference cell, a loading of the interference cell, and a channel type.

3. The control method for the RAS and IC of claim 1, wherein the plurality of parameters comprise an interference-to-noise ratio (INR), a signal-to-interference-plus-noise ratio (SINR), a block error rate (BLER), a throughput (Tput) degradation ratio and a downlink control information (DCI) missing indicator.

4. The control method for the RAS and IC of claim 3, further comprising:
enabling, by the processor, the IC module in an event that the INR exceeds a threshold; and
disabling, by the processor, the IC module in an event that the INR does not exceed the threshold.

5. The control method for the RAS and IC of claim 3, further comprising:
determining, by the processor, to use a first number of antennas in an event that the SINR exceeds a threshold; and
determining, by the processor, to use a second number of antennas in an event that the SINR does not exceed the threshold,
wherein the second number is higher than the first number, and wherein the first number is 1 or higher than 1, and the second number is higher than 1.

6. An apparatus, comprising:
a transceiver, comprising a plurality of antennas and configured to perform wireless transmission and reception to and from a network node; and
a processor, coupled to the transceiver, and performing operations comprising:
determining at least one scenario associated with an operating environment of the apparatus; and
determining a plurality of parameters that correspond to the at least one scenario; and
according to the plurality of parameters, determining a number of antennas which need to be used and determining whether to enable an IC module.

7. The apparatus of claim 6, wherein the at least one scenario comprises a transmission mode, a cell identification (ID) of an interference cell, a loading of the interference cell, and a channel type.

8. The apparatus of claim 6, wherein the plurality of parameters comprise an interference-to-noise ratio (INR), a signal-to-interference-plus-noise ratio (SINR), a block error rate (BLER), a throughput (Tput) degradation ratio and a downlink control information (DCI) missing indicator.

9. The apparatus of claim 8, wherein the processor performs operations comprising:
enabling the IC module in an event that the INR exceeds a threshold; and
disabling the IC module in an event that the INR does not exceed the threshold.

10. The apparatus of claim 8, wherein the processor performs operations comprising:
determining to use a first number of antennas in an event that the SINR exceeds a threshold; and
determining to use a second number of antennas in an event that the SINR does not exceed the threshold,
wherein the second number is higher than the first number, and wherein the first number is 1 or higher than 1, and the second number is higher than 1.
